(19) United States
(12) Patent Application Publication
(10) Pub. No.: US 2026/0003624 A1
(43) Pub. Date: Jan. 1, 2026

(54) MULTI-INSTRUCTION FUSION

(71) Applicant: Advanced Micro Devices, Inc., Santa Clara, CA (US)

(72) Inventors: Daniel Simon McFarlin, Santa Clara, CA (US); John Kalamatianos, Boxborough, MA (US)

(73) Assignee: Advanced Micro Devices, Inc., Santa Clara, CA (US)

(21) Appl. No.: 18/754,278

(22) Filed: Jun. 26, 2024

(51) Int. Cl. G06F 9/30; G06F 9/38

(52) U.S. Cl. CPC G06F 9/30181; G06F 9/3853

(57) ABSTRACT

The disclosed processing device can fuse two instructions into a fused instruction and save metadata corresponding to one of the instructions. The metadata allows the instruction to be performed as needed to generate intermediate values not output from the fused instruction. Various other methods, systems, and computer-readable media are also disclosed.

### BACKGROUND

With increasing computing performance requirements, computing devices have advanced to meet these ever-increasing requirements. These advancements often include improved architectures and other changes to processor designs. However, other improvements can include improvements to workflows, resource utilization, and/or power consumption.

For example, processors often use various techniques to more efficiently process instructions. More efficient instruction pipelines can improve performance without significant architectural changes. However, certain techniques can be difficult to implement. For example, reducing instructions by fusing two instructions into one instruction is often limited to very specific scenarios.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for multi-instruction fusion.

FIG. 2 is a diagram of an example multi-instruction fusion.

FIG. 3 is a diagram of another example multi-instruction fusion.

FIG. 4 is a flow diagram of an exemplary method for multi-instruction fusion.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to multi-instruction fusion. As will be explained in greater detail below, implementations of the present disclosure fuse two instructions into a single fused instruction that is performed instead of the original two instructions. By saving metadata with respect to one or more intermediate values that are skipped due to the fusion, the systems and methods described herein can advantageously apply instruction fusion more often while retaining compatibility with the original instruction sequences. The systems and methods herein can improve a processor's instruction throughput as well as reduce power consumption by using the instruction fusion described herein.

Features from any of the implementations described herein can be used in combination with one another in accordance with the general principles described herein. These and other implementations, features, and advantages will be more fully understood upon reading the following detailed description in conjunction with the accompanying drawings and claims.

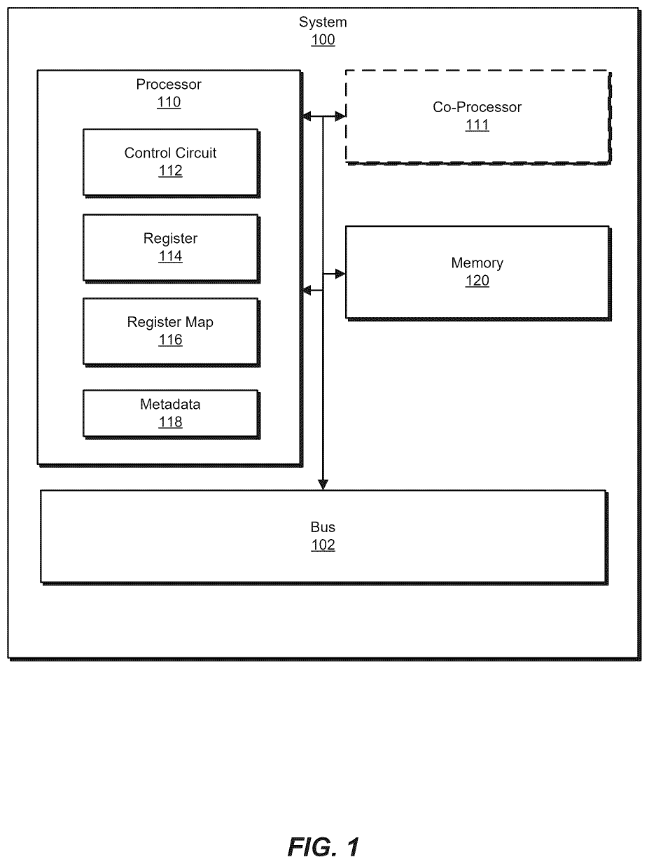

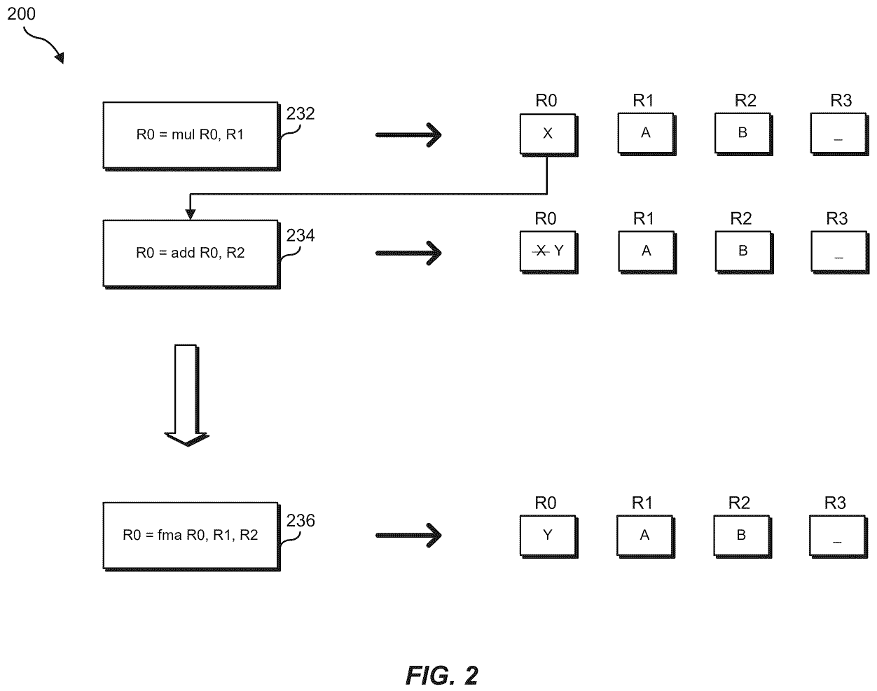

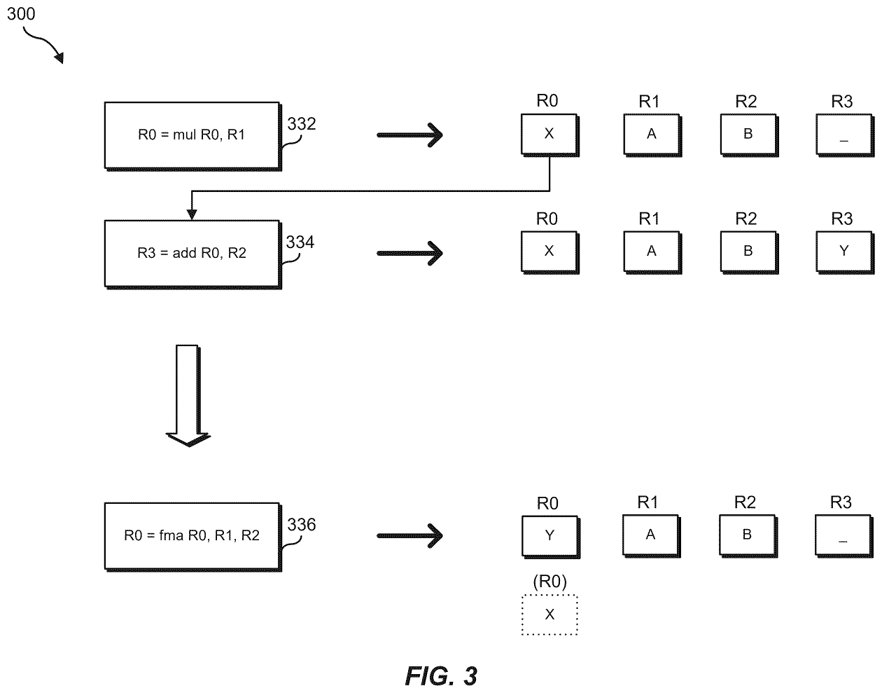

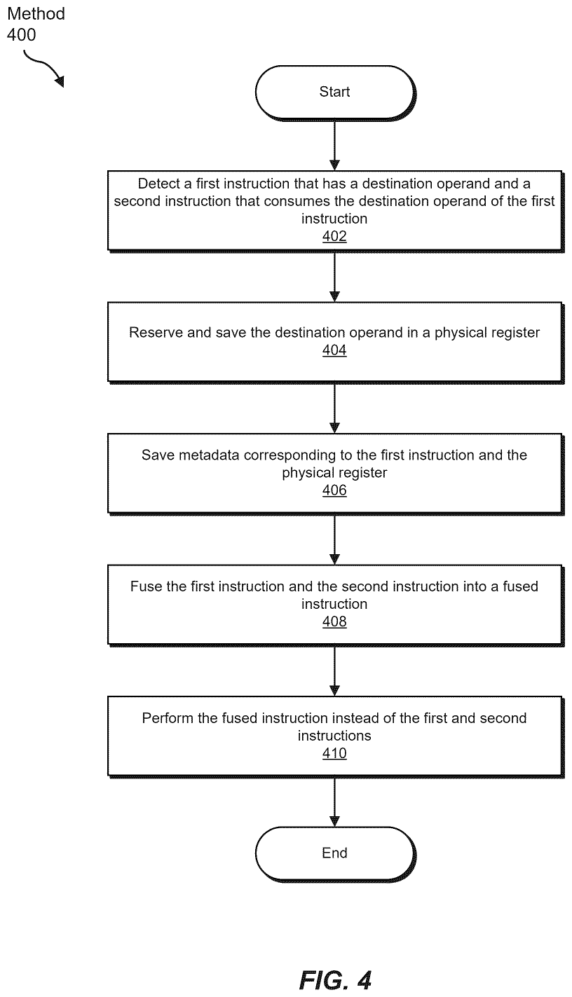

The following will provide, with reference to FIGS. 1-4, detailed descriptions of multi-instruction fusion. Detailed descriptions of example systems will be provided in connection with FIG. 1. Detailed descriptions of example instruction fusion will be provided in connection with FIGS. 2 and 3. Detailed descriptions of corresponding computer-implemented methods will also be provided in connection with FIG. 4.

FIG. 1 is a block diagram of an example system 100 for multi-instruction fusion. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some implementations, system 100 can be coupled to a display device (e.g., via bus 102).

In some implementations, an instruction can generally refer to computer code that can be read and executed by a processor. Examples of instructions include, without limitation, macro-instructions (e.g., program code that requires a processor to decode into processor instructions that the processor can directly execute) and micro-operations (e.g., low-level processor instructions that can be decoded from a macro-instruction and that form parts of the macro-instruction). In some implementations, micro-operations correspond to the most basic operations achievable by a processor and therefore can further be organized into micro-instructions (e.g., a set of micro-operations executed simultaneously).

As further illustrated in FIG. 1, processor 110 includes a control circuit 112, a register 114, a register map 116, and metadata 118. Control circuit 112 corresponds to circuits/circuitry and/or instructions for instruction fusion and can correspond to one or more portions of an instruction pipeline for performing instructions. Register 114 corresponds to a local storage of processor 110 for storing data (e.g., operands for operations) for performing instructions, and can be mapped to architectural registers, such as during a rename phase of an instruction pipeline. Register map 116 corresponds to a map that can track which physical registers (e.g., register 114) are mapped to which architectural registers for a given instruction window of instructions. Metadata 118 corresponds to metadata that allows reproducing an instruction that was fused), as will be explained further below. Metadata 118 can be stored in its own data structure (e.g., a separate table) or as part of another structure and/or reference another structure (e.g., register map 116).

In some examples of an instruction pipeline, processor 110 (and/or a functional unit thereof) reads program instructions from memory 120 and decode the read program instructions into micro-operations. Processor 110 (and/or a functional unit thereof) forwards the newly decoded micro-operations to a scheduler (which can correspond to control circuit 112), and the decoded micro-operations are stored in a buffer, along with any dependencies between instructions tracked. A dependency can generally refer to an instruction (e.g., a consumer) which uses the result/output of another instruction (e.g., a producer) as its own input/operand, such that the consumer depends on the producer. When an execution unit of processor 110 is available to execute a micro-operation, a dispatcher (which can correspond to control circuit 112) can pick a ready micro-operation from the buffer (e.g., having its dependencies resolved) and dispatch it to the available execution unit.

In some examples, control circuit 112 can fuse two instructions into a single instruction. For example, two instructions, which can each correspond to (e.g., be assigned to) respective execution units, can be fused into a single instruction that occupies only one scheduler entry and is assigned to its own respective execution unit such that performance is improved (e.g., reduced power consumption, lower execution latency, more efficient utilization of computing resources such as schedulers, etc.) from using a single execution unit rather two execution units. For example, processor 110 can include a multiply unit, an add unit, and a fused multiply-add (FMA) unit. Although the examples described herein refer to FMA-based instruction fusion, in other examples other types of instructions can be fused.

In some implementations, control circuit 112 can dynamically fuse instructions (e.g., fuse instructions as they are received in the instruction pipeline). For instance, control circuit 112 can observe instructions in an instruction window of the instruction pipeline to identify candidates for fusion.

Certain instructions can be fused. For example, two instructions in which one of the instructions depends on the other instruction can be fused. FIG. 2 illustrates a diagram 200 of an example instruction fusion. FIG. 2 illustrates an instruction 232, and instruction 234, which may correspond to instructions in an instruction window, and a fused instruction 236, along with architectural registers R0, R1, R2, and R3.

Instruction 232 corresponds to a multiply instruction using values in R0 and R1 as operands, the result of which is saved in R0 (e.g., X in FIG. 2). Instruction 234 corresponds to an add operation that depends on instruction 232 such that instruction 232 is a producer and instruction 234 is a consumer. Instruction 234 has operands of R0 (e.g., the result of instruction 232 and thus depending on instruction 232), and R2, and the result of the operation is stored in R0, (e.g., Y), overwriting the previous value stored therein, namely the result of instruction 232.

In FIG. 2, instruction 234 can immediately follow instruction 232 such that the intermediate value (e.g., X as stored in R0 after instruction 232 is completed) is not used by other instructions. For instance, there are no other dependencies on this intermediate value, and instruction 234 is the only consumer of instruction 232, which can be further guaranteed because the intermediate value is overwritten by the consumer. In other words, instruction 232 and instruction 234 result in a single output register (e.g., register R0).

In the scenario of FIG. 2, instruction 232 and instruction 234 can be fused into instruction 236 without affecting other instructions (e.g., later instructions that may be in the same or different instruction windows). Thus, instruction 236, corresponding to an FMA operation having the same operands as the original base instructions (e.g., R0 and R1 from instruction 232, and R2 from instruction 234, with the intermediate value being folded into the fused operation itself) can replace instruction 232 and instruction 234 in the instruction window for improved performance and efficiency. As further illustrated in FIG. 2, the resulting values in the architectural registers can be the same as if the original instructions were performed, with no open/unknown dependencies.

In some implementations, control circuit 112 can detect that the intermediate R0 is dynamically dead (e.g., being immediately overwritten/redefined) such that control circuit 112 can identify the corresponding related instructions (e.g., instruction 232 and instruction 234) as fusable. Control circuit 112 can further identify the operations themselves to determine that a fused operation (e.g., a corresponding functional unit) is available to fuse the instructions and replace the original instructions with the fused instruction (e.g., instruction 236) in the instruction window.

However, the conditions for instruction fusion as represented by FIG. 2 can, in some examples, result in few instruction fusions for a given program. More specifically, the requirement that the two base instructions have the same output register ensures that fusion does not have to update the register file with the output register of the first instruction but can reduce the opportunity for instruction fusion. FIG. 3 illustrates a diagram 300 of another example instruction fusion.

FIG. 3 illustrates an instruction 332, and instruction 334, which may correspond to instructions in an instruction window, and a fused instruction 336, along with architectural registers R0, R1, R2, and R3. Instruction 332 corresponds to a multiply instruction using values in R0 and R1 as operands, the result of which is saved in R0 (e.g., X in FIG. 3). Instruction 334 corresponds to an add operation that depends on instruction 332 such that instruction 332 is a producer and instruction 334 is a consumer. Instruction 334 has operands of R0 (e.g., the result of instruction 332 and thus depending on instruction 332), and R2, and the result of the operation is stored in R3, (e.g., Y), such that R0 is not overwritten, in contrast to FIG. 2.

In the scenario of FIG. 3, instruction 332 and instruction 334 can be fused into instruction 336. Instruction 336 can correspond to an FMA operation having the same operands as the original base instructions (e.g., R0 and R1 from instruction 332, and R2 from instruction 334, with the intermediate value being folded into the fused operation itself). In some implementations, to reduce complexity and further allow scalability, instruction 332 (and the corresponding FMA unit) can reference a limited number of registers. For example, limiting the FMA unit to reference (e.g., either as inputs and/or outputs) three registers (e.g., corresponding to a number of operands) can reduce complexity rather than having a complex FMA unit reference more registers (such as multiple output registers). Although replacing instruction 332 and instruction 334 in the instruction window with instruction 336 can improve performance and efficiency, as further illustrated in FIG. 3, the resulting values in the architectural registers can differ from the original instructions. More importantly, the intermediate value of R0 (e.g., X) is not written to the register file and cannot be accessed by a younger instruction.

In FIG. 3, even if instruction 334 immediately follows instruction 332, the lack of storage for the intermediate value X in R0 can prevent another instruction (e.g., a younger instruction) from consuming it. For instance, another instruction outside of the instruction window could potentially consume it. In other words, there is no guarantee that there is no future dependency on the intermediate value. In addition, it can be unfeasible or otherwise require additional complexity/overhead to reconfigure the register outputs and emulate the effects of the original code sequence. For example, control circuit 112 can incur overhead in smartly reallocating registers. Moreover, in some examples, the fused operation itself does not store the intermediate result such that the intermediate result can require a separate operation, negating the benefits of instruction fusion.

To address these issues, control circuit 112 can store metadata (e.g., metadata 118) corresponding to the intermediate value as part of the instruction fusion process. Metadata 118 can include metadata that allows the intermediate value to be recalculated as needed. For instance, metadata 118 can include references to the initial operands and the operation itself such that the intermediate value can be recalculated. Control circuit 112 can preserve the physical registers (e.g., one or more of register 114 by not mapping to architectural registers) holding the initial operand values and include references to these physical registers in metadata 118 as operands. Additionally, metadata 118 can include a reference to an output register (e.g., architectural register) of the operation (such as R0 for instruction 332) such that the recalculated result is stored in the appropriate architectural register. Further, in some implementations, metadata 118 can include or otherwise be associated with a counter or other dependency tracking mechanism, in order to track references to the intermediate value, which can be tracked based on references to the output architectural register.

In some implementations, control circuit 112 can store metadata 118 in a table or other data structure, which can be independent or part of another existing structure such as a register map (e.g., register map 116) that can store architectural mappings, although in other examples can be stored in any other appropriate data structure. For instance, metadata 118 can be stored in a way to facilitate dependency tracking. In some examples, control circuit 112 can discard metadata 118, such as in response to certain triggers. For example, control circuit 112 can keep track of references to metadata 118. If control circuit 112 performs the operation as indicated in metadata 118, control circuit 112 can decrement the counter. If the counter reaches 0 (e.g., no references), which in some implementations can further include a threshold number of cycles/instructions elapsing without an increment to the counter, control circuit 112 can discard or otherwise free metadata 118. In yet other examples, if a reference to the output register includes overriding the output register, control circuit 112 can also discard or otherwise free metadata 118. In further examples, if a producer instruction, that outputs to a register referenced in metadata 118, retires, control circuit 112 can also discard metadata 118. When the producer instruction retires, the operation of metadata 118 would also not be needed as its producer is retired. Moreover, metadata 118 can include a reference to the instruction window entry such that metadata 118 can be retired within the instruction window.

Accordingly, for the example of FIG. 3, control circuit 112 can save metadata for value X that includes an indication/reference of a multiply operation (for instruction 332), as well as physical registers mapped to R0 and R1 holding the initial operand values. In some examples, control circuit 112 can remap an output architectural register for the fused instruction (e.g., having the output R0 for instruction 336 map to a different physical register) to preserve the initial operands, although in other examples, control circuit 112 can copy one or more of the initial operand values into other physical registers, such as physical registers not used for mapping architectural registers.

In some implementations, control circuit 112 can perform (e.g., via appropriate control/coordination of processor 110 and units thereof), the operation in metadata 118 in response to one or more triggers. In some examples, control circuit 112 can encounter, such as in subsequent instructions entering the instruction window, an instruction that consumes or otherwise references the intermediate value based on the reference to the architectural register (e.g., R0 in FIG. 3). In some examples, register map 116 can include a reference to or otherwise include metadata 118. Control circuit 112 can detect this reference and accordingly recalculate the intermediate value using metadata 118, which in some implementations can be identified from register map 116 (e.g., register map 116 having a pointer to metadata 118 for R0).

In other examples, control circuit 112 can recreate the original intended architectural register state (e.g., the values of the architectural registers after performing instruction 334 in FIG. 3). For instance, control circuit 112 can perform the operation in response to a context switch, in which register values are stored as a context allowing processor 110 to switch to a different program, and restore the context to resume the current program. In yet other examples, an error exception corresponding to the fused instruction (e.g., instruction 336 which can further correspond to instruction 332 and/or instruction 334) can trigger control circuit 112 to perform the operation and recreate the intermediate value. Handling the error exception can include reading the corresponding architectural registers.

Accordingly, by saving metadata 118 as described herein, control circuit 112 can perform dynamic instruction fusion, and recreate as needed any intermediate values not stored due to fusion. The increased opportunities for instruction fusion, balanced against overhead for recalculating values, can lead to overall performance benefits as described herein.

FIG. 4 is a flow diagram of an exemplary computer-implemented method 400 for multi-instruction fusion. The steps shown in FIG. 4 can be performed by any suitable computer-executable code and/or computing system, including the system(s) illustrated in FIG. 1. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein detect a first instruction that has a destination operand and a second instruction that consumes the destination operand of the first instruction. For example, control circuit 112 can detect instruction 332 and instruction 334 that depends on instruction 332.

The systems described herein can perform step 402 in a variety of ways. In one example, control circuit 112 can also detect the instructions based on registers. For instance, control circuit 112 can detect two consecutive instructions in which the producer instruction has no other consumer instruction in the given instruction window. In other examples, control circuit 112 can select non-consecutive instructions having an appropriate dependency.

At step 404 one or more of the systems described herein reserve and save the destination operand in a physical register. For example, control circuit 112 can save the operands of instruction 332 in register 114.

The systems described herein can perform step 404 in a variety of ways. In one example, control circuit 112 reserves physical registers (e.g., having the physical register unavailable for assigning/renaming as architectural registers) for the destination operands of the original instruction sequence even if the fused instruction does not produce them. In other examples, control circuit 112 can copy the destination operands to other physical registers, such as reserving different physical registers for the destination operands.

At step 406 one or more of the systems described herein save metadata corresponding to the first instruction and the physical register. For example, control circuit 112 can save metadata 118 as described herein.

The systems described herein can perform step 406 in a variety of ways. In one example, control circuit 112 can save metadata 118 in register map 116. In other examples, control circuit 112 can save metadata 118 in other data structures. Further, control circuit 112 can save metadata 118 in any format as needed.

At step 408 one or more of the systems described herein fuse the first instruction and the second instruction into a fused instruction. For example, control circuit 112 can fuse instruction 332 and instruction 334 into instruction 336 as described herein.

The systems described herein can perform step 408 in a variety of ways. In one example, control circuit 112 can look up (e.g., in a table) which operations can be fused into which operations, which can further indicate which operands of the original instructions to be used for which operands of the fused instruction.

At step 410 one or more of the systems described herein perform the fused instruction instead of the first and second instructions. For example, control circuit 112 can perform the fused instruction (e.g., by instructing processor 110 to perform instruction 336 such that instruction 336 is processed through an instruction pipeline of processor 110, as described herein, for execution by an execution unit, a logic unit, and/or other circuit for executing decoded instructions).

The systems described herein can perform step 410 in a variety of ways. In one example, control circuit 112 can replace instruction 332 and instruction 334 with instruction 336 in the instruction window (e.g., rather than storing decoded instructions for instruction 332 and instruction 334 in a decoded instruction buffer, dispatching instruction 336 rather than instruction 332 and instruction 334, etc.).

Further, in some examples, control circuit 112 can perform the first instruction (e.g., instruction 332) to produce an intermediate value in an output register of the first instruction in response to a third instruction consuming that intermediate value from the first instruction, as described herein. Control circuit 112 can further discard metadata 118, as described herein.

As detailed above, instruction or micro-operation (uop) fusion can merge two consecutive instructions or uops into one, such as when dispatching them to the backend of a CPU core. The resulting single, fused instruction can be restricted to a single live-out destination register, which can restrict the scope of dynamically fusable instructions to instruction sequences where the older instruction(s)' destinations are sourced and overwritten by the younger instruction(s). The systems and methods provided herein can relax this restriction by permitting multiple live-out destination registers in a fused sequence. The live-out destination values are not computed by the fused sequence but can be individually computed on-demand when younger consumers of the live-out destination registers are encountered, after the fused sequence is executed. This permits fusion of more instruction sequences while minimizing duplicate work, necessitated by executing the instructions which define the intermediate registers.

The systems and methods herein provide for tracking metadata to regenerate intermediate values of a fused instruction sequence via a separate table along with an extension to a register map used by a CPU processor. This table can be populated with the metadata after dispatch and is indexed by the instruction window id assigned to the instruction of the fused sequence that generates the intermediate value. As a result, it can be flushed during a pipeline flush event (e.g., branch misprediction, trap, etc.). The register map entry corresponding to the architected/architectural register, defining an intermediate value in a fused sequence, stores the table index that includes the metadata needed to generate the actual intermediate value held by that architected register. The metadata can include the instruction opcode, the physical register numbers (PRNs) of its source register operands and the architected register holding the intermediate value. The metadata can be used when (a) the intermediate value needs to be consumed by a younger instruction/uop, found after the fused instruction sequence or (b) when the precise architectural state needs to be recreated. If the hardware can guarantee that there is no younger consumer of the intermediate value, this metadata can be discarded. In some examples, this point corresponds to when the next producer of the architected register, which holds the intermediate value, commits.

The register mapper can maintain precise exception support (via checkpointing, etc.). The metadata table can support precise exceptions by being flushed and repopulated whenever a pipeline gets flushed (e.g., branch mispredictions, traps, etc.), which in some implementations is due to being indexed by the instruction window id, similar to other hardware structures (e.g., instruction schedulers).

Intermediate results from the live out registers of a fused instruction sequence can be generated before dispatch, on the fly, via fixup instructions/uops, when a consumer of the intermediate result is detected. Fixup instructions can be issued once per intermediate value, independent of the consumers (outside the fused instruction sequence). Fixup instructions can also update the physical register file (PRF) and assign a physical register location for the intermediate value using the existing register mapper entry (that points to the metadata entry before the fixup instruction). The metadata entry can be cleared when (a) the fixup instruction commits or (b) next producer of the architected register which produced the intermediate value commits. If the fixup instruction is flushed due to a misprediction, the register mapper checkpoint can restore its contents before the flush event, which can reinstate the pointer to the metadata entry (which is using the instruction window id of the producer instruction of the intermediate value). In another example, the register mapper checkpoint can lie between the fused uop sequence and a next consumer of the architected register whose use-def chain becomes eliminated by the fused pair, and the flush event can be triggered by a uop after the fused pair and after the last register mapper checkpoint. In such a scenario (e.g., fused sequence, last register mapper checkpoint, flush uop, fixup uop), the register mapper checkpoint used to restore the mappings can scan the metadata table and, for every flushed instruction that has a tagged metadata entry, recreate the dropped register mapping and accordingly update the register mapper checkpoint.

As an example, if a subsequent use of R0 is detected in the instruction stream before R0 is redefined, a fixup instruction can be inserted, just before the R0 consumer instruction. If R0 has a single use (e.g., the instruction is inside the fused sequence), then the metadata in the register map can be dropped when the intermediate value can be safely dropped: when the next R0 producer instruction retires. This can be consistent with typical physical register release schemes such that no additional hardware support is required in some implementations. Since the register mapper entry, corresponding to the intermediate value, points to the metadata entry, discarding the metadata entry contents can also be triggered by the event that would have released the PRN entry holding the intermediate value (retirement of next R0 producer instruction). If R0 has been mapped to an actual PRN by a fixup instruction, the metadata entry can already be cleared when the fixup instruction committed.

Whenever a fused instruction that created metadata entry commits, a commit bit in the metadata entry can be set, marking that entry as part of the commit state of the machine. The commit bit can be cleared when the metadata entry is discarded.

In the event of a context switch, the precise state of the machine is saved to memory. In order to accomplish that, the register map can be scanned to sort all valid metadata entries with the commit bit set to 1, based on program order, and issue the instructions pointed by the metadata entries in the same program order. This flow can update the PRF and the register map and clear the metadata table. It can also complete the machine state update allowing the context switch flow to start saving it to memory.

To enable on-demand intermediate value generation, the original source register values of all instructions copied in the metadata table can be saved in case they are needed to regenerate the intermediate value. As an example, the PRNs holding the input value to R0 and R1 at instruction remains intact in the PRF, until the intermediate value of R0 can be discarded. As mentioned above, this can happen when the next producer of R0 retires or when the fixup instruction for R0 retires. The source registers can also be released when their next producers retire. Example conditions for releasing PRNs include: (1) a next producer retires, or (2) a fixup producer retires.

The condition that is met last in time can trigger the release of a PRN Px. As mentioned above, the third condition can occur either at a context switch or when a source register Rx has a younger consumer, outside of the fused sequence. The second and third conditions can be mutually exclusive in some examples, and the first and second conditions can depend on the original program.

The first condition can be checked by searching the metadata entries for matches with the PRN of the source operands. If there are 1 or more matches and the “ready to commit” bit for all matches is set to 1, then the PRN Px can be released. If there is no match, the PRN Px can be released. If there is at least one match with the “ready to commit” bit set to 0, Px is not released. Instead, the “ready to commit” bit is set to 1.

The second and third conditions can be checked by (a) detecting an intermediate value for an intermediate destination register via the register map and (b) checking all of the source PRNs tracked in its metadata entry. If a source register entry has been marked as “ready to commit” in the metadata entry, then the PRN Px is released. Otherwise, its “ready to commit” bit is set to 1 and Px is not released.

Although some of the examples described herein correspond to a just-in-time approach with respect to consumers, other examples can instead be based on accommodating branch predictors. For example, if this approach results in stalls for the consumers, and if (in some examples) the fused uop is issued before the fixup uop is marked as ready (which in some examples can be marked as ready at dispatch if the fused uop has been executed by the time the fixup uop is generated), the fixup instruction can be dispatched progressively earlier (e.g., by issuing the instruction earlier such that the latency is covered). Detection can include monitoring ready-at-dispatch stalls. In response to a consistent increase in those stalls in the dispatch group containing the consumer and in those dispatch groups that follow, setting a shift-register delay timer can gradually adjust the issue time of the fixup instruction. Storing data in the uop-cache can persist data about the issue time of the fixup instruction.

In one implementation, a device for multi-instruction fusion includes a control circuit configured to fuse, into a fused instruction, a first instruction with a second instruction that depends on the first instruction, save metadata corresponding to the first instruction, and perform the fused instruction instead of the first and second instructions.

In some examples, the control circuit is further configured to preserve enough metadata to enable potentially preserving a physical register holding a destination operand of the first instruction, although in other examples, the control circuit can save metadata that can help generate a fixup uop, which will reserve the physical register. In some examples, the metadata includes references to the destination architected register of the first instruction, and an operation of the first instruction. In some examples, the control circuit is further configured to not save any metadata in association to the destination architected register of the first instruction in response to no references to the architected register after the second instruction.

In some examples, the control circuit is configured to save the metadata in a register map. In some examples, the control circuit is further configured to perform the first instruction to produce an intermediate value in an output register of the first instruction. In some examples, the control circuit is configured to perform the first instruction in response to a third instruction depending on the destination register of the first instruction. In some examples, the control circuit is configured to perform the first instruction in response to a context switch. In some examples, the control circuit is configured to perform the first instruction in response to an error exception corresponding to the fused instruction. In some examples, the control circuit is configured to discard the metadata in response to performing the first instruction. In some examples, the control circuit is configured to perform the first instruction as a result of a pipeline flush after the fused instruction.

In some examples, the control circuit is configured to discard the metadata in response to a register that is referenced in the metadata is overwritten. In some examples, the control circuit is configured to discard the metadata in response to a producer, that outputs to a register that is referenced in the metadata, retiring.

In one implementation, a system for multi-instruction fusion includes a memory, and a processor comprising a physical register, and a control circuit. In some examples, the control circuit is configured to fuse, into a fused instruction, a first instruction that has an operand with a second instruction that depends on the first instruction, save, in a register map, metadata corresponding to the first instruction and the operand in the physical register, and perform the fused instruction instead of the first and second instructions.

In some examples, the metadata includes references to the output register of the first instruction, and an operation of the first instruction. In some examples, the control circuit is further configured to not reserve in the register map any metadata in response to no references to the architected register. In some examples, the control circuit is further configured to perform the first instruction to produce an intermediate value in an output register of the first instruction in response to a third instruction depending on the destination register of the first instruction. In some examples, the control circuit is configured to perform the first instruction in response to at least one of a context switch, an error exception corresponding to the fused instruction, a pipeline flush event after the fused instruction or performing the first instruction.

In some examples, the control circuit is configured to discard the metadata in response to at least one of a register that is referenced in the metadata is overwritten or a producer, that outputs to a register that is referenced in the metadata, retires.

In one implementation, a method for multi-instruction fusion includes (i) detecting a first instruction that has an operand and a second instruction that depends on the first instruction, (ii) saving metadata corresponding to the first instruction and its destination register, (iii) fusing the first instruction and the second instruction into a fused instruction, and (iv) performing the fused instruction instead of the first and second instructions.

In some examples, the method further includes performing the first instruction to produce an intermediate value in an output register of the first instruction in response to a third instruction depending on the first instruction and discarding the metadata.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAS that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a control circuit configured to:
fuse, into a fused instruction, a first instruction with a second instruction that depends on the first instruction;
save metadata corresponding to the first instruction; and
perform the fused instruction instead of the first and second instructions.

2. The device of claim 1, wherein the control circuit is further configured to preserve the metadata that maps a physical register holding a destination operand of the first instruction.

3. The device of claim 2, wherein the metadata includes references to an output register of the first instruction, and an operation of the first instruction.

4. The device of claim 3, wherein the control circuit is further configured to free the metadata in response to the output register of the first instruction having no additional references outside of the fused instruction.

5. The device of claim 1, wherein the control circuit is configured to save the metadata in a register map.

6. The device of claim 1, the control circuit is further configured to perform the first instruction to produce an intermediate value for an output register of the first instruction.

7. The device of claim 6, wherein the control circuit is configured to perform the first instruction in response to a third instruction depending on the first instruction.

8. The device of claim 6, wherein the control circuit is configured to perform the first instruction in response to a context switch.

9. The device of claim 6, wherein the control circuit is configured to perform the first instruction in response to an error exception corresponding to the fused instruction.

10. The device of claim 6, wherein the control circuit is configured to discard the metadata in response to retiring the first instruction.

11. The device of claim 6, wherein the control circuit is configured to perform the first instruction as a result of a pipeline flush after the fused instruction.

12. The device of claim 1, wherein the control circuit is configured to discard the metadata in response to a producer, that outputs to a register that is referenced in the metadata, retiring.

13. A system comprising:
a memory; and
a processor comprising:
a physical register; and
a control circuit configured to:
fuse, into a fused instruction, a first instruction that has a destination operand with a second instruction that depends on the first instruction;
save, in a register map associated with the physical register, metadata corresponding to the first instruction and the destination operand; and
perform the fused instruction instead of the first and second instructions.

14. The system of claim 13, wherein the metadata includes references to an output register of the first instruction, and an operation of the first instruction.

15. The system of claim 13, wherein the control circuit is further configured to free the metadata in response to an output register of the first instruction having no additional references outside of the fused instruction.

16. The system of claim 13, wherein the control circuit is further configured to perform the first instruction to produce an intermediate value for an output register of the first instruction in response to a third instruction depending on the first instruction.

17. The system of claim 16, wherein the control circuit is configured to perform the first instruction in response to at least one of a context switch, an error exception corresponding to the fused instruction, a pipeline flush event after the fused instruction, or performing the first instruction.

18. The system of claim 13, wherein the control circuit is configured to discard the metadata in response to a producer, that outputs to a register that is referenced in the metadata, retiring.

19. A method comprising:
detecting a first instruction that has a destination operand and a second instruction that consumes the destination operand of the first instruction;
saving metadata corresponding to the first instruction and a destination register corresponding to the destination operand;
fusing the first instruction and the second instruction into a fused instruction; and
performing the fused instruction instead of the first and second instructions.

20. The method of claim 19, further comprising:
performing the first instruction to produce an intermediate value in an output register of the first instruction in response to a third instruction depending on the first instruction; and
discarding the metadata.
